(19) United States
(12) Patent Application Publication
(10) Pub. No.: US 2008/0055923 A1
(43) Pub. Date: Mar. 6, 2008

(54) High efficiency light projector

(76) Inventors: Jack V. Miller, Seaford, DE (US); Ruth Ellen Miller, Seaford, DE (US)

Correspondence Address: Jack V. Miller, 20915 Sussex Highway, Seaford, DE, 19973, US

(21) Appl. No.: 11/515,989

(22) Filed: Sep. 6, 2006

(51) Int. Cl. F21V 33/00; F21V 7/08

(52) U.S. Cl. 362/580

(57) ABSTRACT

The light projector of the invention includes a lamp, a full-ellipsoidal reflector and an elongated glass rod on an optical axis, with the light source at the primary focus and the proximal end of the glass rod at the conjugate focus. A transverse, infrared-reflecting, visible light transmitting mirror is disposed within the reflector at the mid-point of the optical axis between the primary focus and the conjugate focus. A preferred embodiment of the reflector has a proximal conical end and a conical distal end, a reflective surface within the reflector and an emissive exterior surface including cooling fins.

### BACKGROUND

1. Field of the Invention

This invention applies to the field of projection lamps capable of focussing intense light from a small source of illumination through a relatively small aperture. Such projectors are widely used for fiber optics illumination, image projection and for controlled illumination wherein an image of the small aperture is optically projected onto a surface with little or no surrounding spill light.

2. Description of Prior Art

Current projectors utilize small light sources, such as incandescent filaments or short arc tubes. Their optical systems use light sources at the primary focus of partial ellipsoidal reflectors at the proximal end of an optical axis, wherein the reflector focusses the light in the distal direction to an aperture at the conjugate focus. The aperture may be simply an image-shaping aperture in a thin metal plate, a bundle of optical fibers (plastic or glass) or movie or still frame graphics that are sensitive to the intense heat light accompanying the light.

It is well known that incandescent lamps emit approximately 93% of their energy as IR; and that arc lamps such as metal halide lamps, emit over 80% of their energy as IR heat. Contrary to some manufacturers' claims, even glass fiber optics cables are subject to damage from focussed lamp heat. The glass fibers in the common end bushing of a fiber optic cable must be held together with a bonding material, such as epoxy, for polishing. The epoxy is literally cooked in the light and heat until it falls apart. Some manufacturers of plastic fiber optics cables instruct users to leave an extra 5 feet of cable at the input end, so it can be regularly cut off as the common end “caramelizes” (melts, discolors and burns).

One method for efficiently removing the heat from the focussed light is as shown approximately in prior art FIG. 1. One skilled in the lighting art will recognize the lamp in FIG. 1 as an “MR-16”, a widely used projector lamp available from 50 watts to 250 watts. The “MR” means miniature reflector, and the “16” means the reflector is 16/8ths, or 2 inches in diameter. The partial ellipsoidal reflector is glass, with the inner surface having a dichroic coating that transmits a large portion of the incident IR (infrared heat) and reflects most of the visible light and the remaining portion of the IR to the conjugate focus of the reflector. The glass rod in FIG. 1 is an elongated, heat-absorbing glass rod on the optical axis, with a proximal end at the conjugate focus of the reflector, and the distal end of the glass rod emitting the visible portion of the light spectrum. According to the Second Law of Thermodynamics, heat will always move from a hotter area to a cooler one. Thus the IR focussed onto the proximal end of the glass rod is conducted into the rod to the cooler exterior, to be radiated and/or conducted to the yet cooler surrounding medium.

The heat removal is very efficient in FIG. 2, the applicants' prior art patent U.S. Pat. No. 5,099,399. The spectral filtration of the dichroic reflector surface, conduction through and away from the glass rod, natural convection and fan ventilation, plus IR radiation, effectively removes virtually all the lamp heat from the visible light, so the distal end of the glass rod is actually cool to the touch, even when operating with a 150-watt lamp. This method is also shown in applicants' prior art patent U.S. Pat. No. 6,409,524 of FIG. 3, and several other patents cited as prior art.

Although the above described patents to some degree do remove the lamp heat with varying degrees of success, they all have three causes for the waste a substantial amount of light that does not pass through the glass rod.

The first cause is shown in FIGS. 1 and 2, in which a substantial portion of the radiation from the light source simply misses both the reflector and the proximal end of the glass rod as wasted heat and light.

The second cause is the loss of heat and light that passes through the dichroic reflector, as described above. The dichroic coating allows a substantial amount of the IR (lamp heat) and some visible light to pass through the reflector, with the rest of the heat and light being focussed onto the proximal end of the glass rod. As stated above, incandescent lamps emit 93% of their energy as IR. Since the lamp relies on maintaining the filament temperature of about 3,000° Kelvin to produce light, that lost 93% of lamp energy must be replaced, either as increased input power or by a more efficient thermal design.

The third cause is the loss of heat and light at the conjugate focal plane as shown in FIG. 3 from applicants' U.S. Pat. No. 5,967,653. The lamp shown in FIG. 3 is an “MR-8” in which the reflector is 8/8ths (1 inch) in diameter and has a very short focal length that is less than the reflector rim diameter. The rays from the rim of the reflector are the most sharply focussed, but due to the short focal length they hit the conjugate focal plane at shallow angles. Thus they have high grazing reflectance and the reduced portion of the light entering the rod strikes the inner diameter of the glass rod at an angle steeper than Brewster's angle of total internal reflection. Thus much of the light is not transmitted through the glass rod, but is absorbed into the surrounding heat radiator as indicated by the “X” marks.

Each of the above three causes of inefficiency can be substantially reduced by using a “full ellipsoidal reflector” with a relatively long focal length as shown in FIG. 4.

### OBJECTS AND ADVANTAGES OF THE PRESENT INVENTION

The primary object of the present invention is to provide a highly efficient projection lamp that may be used in many applications, including fiber optic projectors, framing projectors, tracklights and ceiling downlights. The present invention makes an improvement over the prior art by substantially reducing both the heat and light losses, characteristic of the conventional partial ellipsoidal reflector lamps shown in FIGS. 1, 2 and 3. The primary object is achieved by the present invention through the use of a full-ellipsoidal reflector as shown in FIG. 4.

The first advantage of the present invention is a substantial reduction in wasted light and heat that misses both reflector and the proximal end of the glass rod.

The second advantage of the present invention is elimination of the loss of heat and light through the dichroic reflector coating.

The third advantage of the present invention is the use of a long focal length full ellipsoidal reflector, eliminating the grazing reflectance of the visible light at the proximal end of the glass rod, whereby the light entering the rod strikes the inner diameter of the glass rod at an angle less than Brewster's angle of total internal reflection, resulting in an increased amount of the light transmitted through the glass rod to exit through distal end.

### BRIEF DESCRIPTION OF THE DRAWINGS

FIG. 1 is a side cross-sectional view of a typical prior art projector optical system using a commercially-available partial-ellipsoidal projector lamp having an IR-transmitting, visible-light-reflecting glass reflector focussing light to and through a glass rod. The primary purpose of FIG. 1 is to identify the nomenclature used in the lighting industry, as well as the language and components used in this patent disclosure.

FIG. 2 is a side cross-sectional view of a typical prior art optical system of applicants' cited prior art U.S. Pat. No. 5,099,399. also using the optics commercially-available partial-ellipsoidal, dichroic-reflector lamp and a glass rod. The reflector lamp is a 150-watt “MR-16” (Miniature Reflector— 16/8ths inch diameter lamp) made by many manufacturers. Thus the lamp in FIG. 2 has a 2-inch diameter reflector a 2.5-inch focal length, shown approximately to scale in FIG. 1.

FIG. 3 is a side cross-sectional view of a typical prior art optical system of applicants' prior art U.S. Pat. No. 5,967,653 using a commercially-available, partial-ellipsoidal MR-8 (Miniature Reflector— 8/8ths, 1-inch diameter) lamp with a glass rod.

FIG. 4 is a side cross-sectional view of a full ellipsoidal reflector ellipsoidal reflector according to the present invention, having an aperture at the conjugate focus plane of the reflector.

FIG. 5 is a side cross-sectional view of the full ellipsoidal reflector of FIG. 4, showing ineffective reflector optical losses in the conjugate focal plane at the proximal end of the glass rod.

FIG. 6 is a side cross-sectional view of a full ellipsoidal reflector ellipsoidal reflector of FIG. 4, according to the present invention, showing tangent conical reflectors that reduce both visible and IR optical losses.

FIG. 7 is a side cross-sectional view of a full ellipsoidal reflector ellipsoidal reflector of FIG. 6, according to the present invention, showing structural and thermal properties.

### DETAILED DESCRIPTION OF THE DRAWINGS

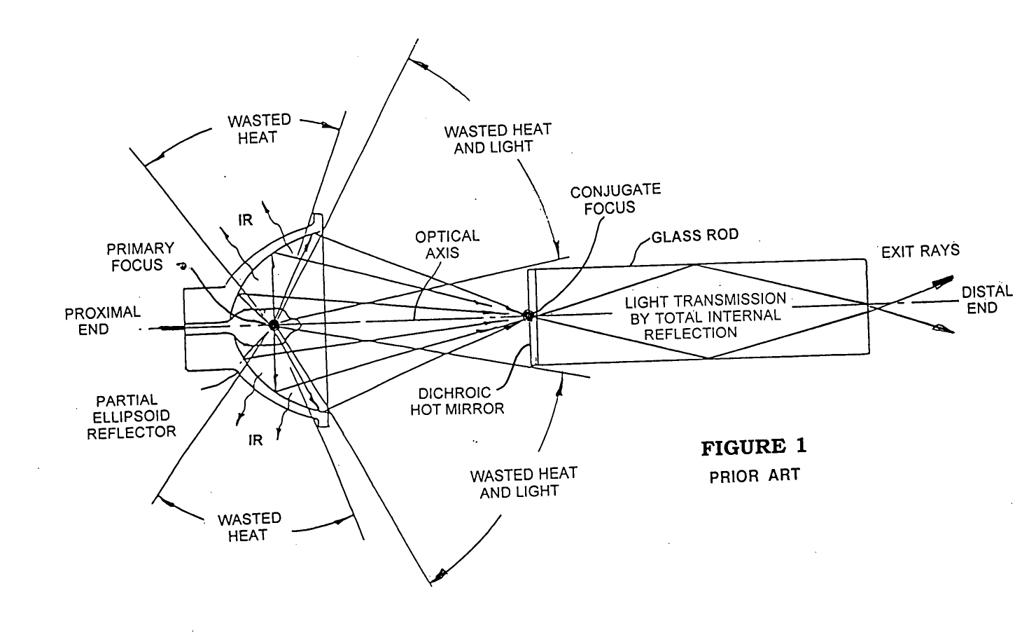

FIG. 1 is a side cross-sectional view of a typical prior art projector optical system using a commercially-available “MR-16” projector lamp with a partial-ellipsoidal reflector having an IR-transmitting, visible-light-reflecting glass reflector focussing light to and through a glass rod. The primary purpose of FIG. 1 is to identify the nomenclature used in the lighting industry, as well as the language and components used in this patent disclosure.

Although the MR-16 lamp is shown diagrammatically as a point source lamp, it is obvious that a lamp filament is of a finite size that radiates light and heat omnidirectionally. The filament is located near the proximal end of the optical axis and a substantial portion of the filament radiation strikes the partial ellipsoid reflector to be focused to the conjugate focus in the distal direction on the optical axis. The reflector is made of glass and has a dichroic “cold mirror” reflecting surface that transmits IR (InfraRed) and reflects visible light. The visible light, with a portion of IR removed, is focussed to the conjugate focus of the ellipsoid at the proximal end of a glass rod on the optical axis.

Since the reflector cold mirror reflects some IR along with the visible light, the proximal end of the glass rod is provided with a IR-reflecting “hot mirror” to reflect incident heat and remove more IR from the light entering the glass rod. Visible light is then transmitted by total internal reflections through the glass rod to exit the rod at its distal end.

The efficiency of the filament radiation is dependent on maintaining the filament temperature, which is ideally around 3,0000 Kelvin. Thus the loss of the heat that is transmitted through the reflector, and the heat that is radiated with light within the angle from the reflector rim to the glass rod are wasted, that energy must be replaced in the filament with electrical power.

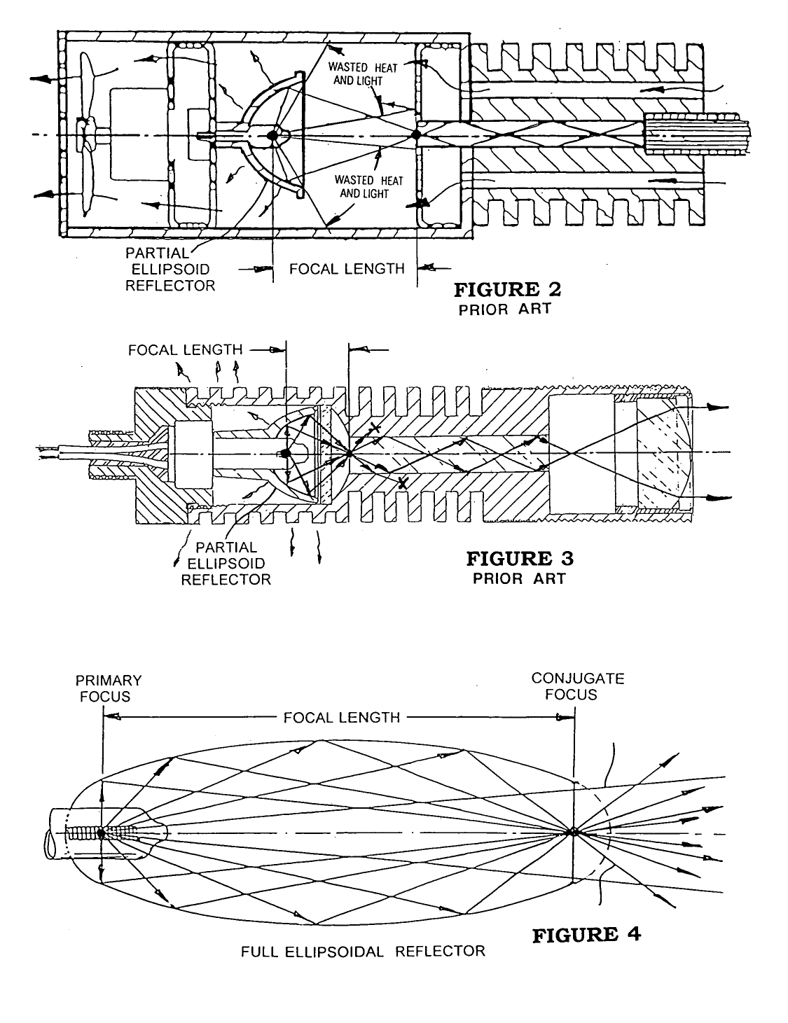

In FIG. 2, applicants' prior art U.S. Pat. No. 5,099,399 for a fiber-optic projector is shown having the same a partial ellipsoid reflector lamp as shown in FIG. 1, with the same glass rod and the same inefficiencies. The '399 patent applies to a fiber optic projector wherein the heat must be removed almost completely to protect the proximal end of the fiber optic cable from heat damage. That thermal control function has been achieved to the degree that fiber optic projectors manufactured according to the '399 patent are warranted for ten years by the applicants. The long-term reliability has proven well worth the losses in efficiency, but the prior art light and heat losses were the motivation for the design of the present invention.

In FIG. 3 applicants' prior art U.S. Pat. No. 5,967,653 uses the same basic optical principles of FIG. 1 and FIG. 2 in a small luminaire (light fixture) wherein the glass rod output passes through a lens instead of the fiber optic cable of FIG. 2. The lamp shown in FIG. 3 is an “MR-8” reflector lamp, 1-inch in diameter, with approximately a 1-inch focal length. The MR-8 reflector lamp, like the MR-16, has a glass reflector with the IR transmitting, visible-light reflecting dichroic surface. This is ideal for small luminaires, but the inherent inefficiencies also give rise to the need for the improvements included in the present invention.

FIG. 4 is a side cross-sectional view of a full ellipsoidal reflector according to the present invention, having a lamp at the primary focus of an optical axis, focusing light generally in the distal direction to the conjugate focus. The light rays shown are idealized to show the theoretical paths from the primary focus at the centroid of the lamp filament to the conjugate focus of the full-ellipsoidal reflector. This arrangement captures a substantial portion of the wasted light of a semi-ellipsoidal lamp of FIG. 1.

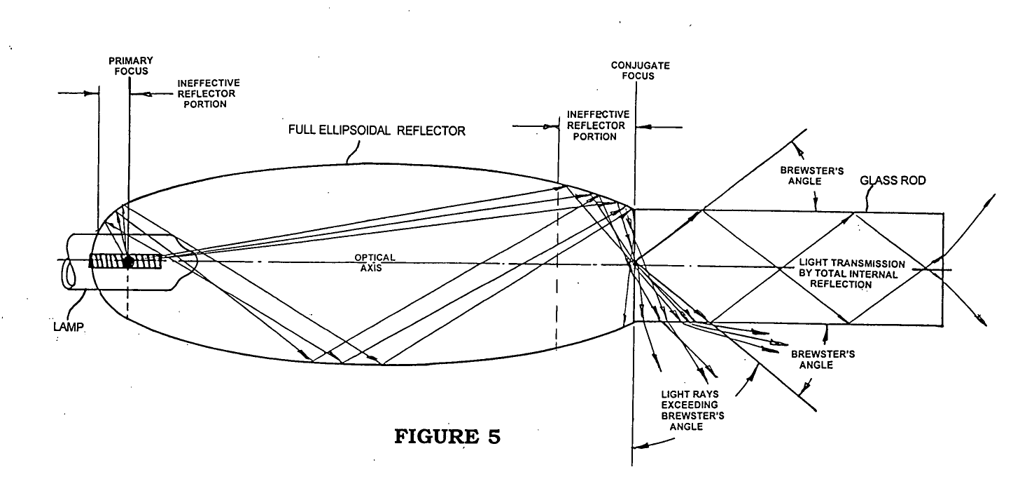

FIG. 5 is a side cross-sectional diagram of the full-ellipsoidal reflector of FIG. 4. Light radiating from the centroid of the lamp filament, striking the ellipsoidal reflector between the proximal ineffective reflector portion and the distal ineffective reflector portion, is reflected to and through the conjugate focus and propagating through the glass rod by total internal reflection as shown in FIG. 1. However, the ineffective reflector portions do not produce usable light per FIG. 1. The light radiating from the centroid of the lamp filament in the proximal ineffective reflector portion of the ellipsoid still ends up at the conjugate focus. However, light radiating from the centroid of the lamp filament in the proximal direction, to the proximal ineffective reflector portion, is reflected to the distal ineffective reflector portion, and to the conjugate focus at angles of incidence that too shallow to efficiently enter the proximal end of the glass rod. Thus most of the light rays at shallow, grazing angles, are reflected off the end of the glass rod. The remaining rays enter the glass rod at angles that exceed Brewster's angle, and instead of propagating through the glass rod by total internal reflection as shown in FIG. 1, the light exits the sides of the glass rod as indicated by the “Xs” in FIG. 3.

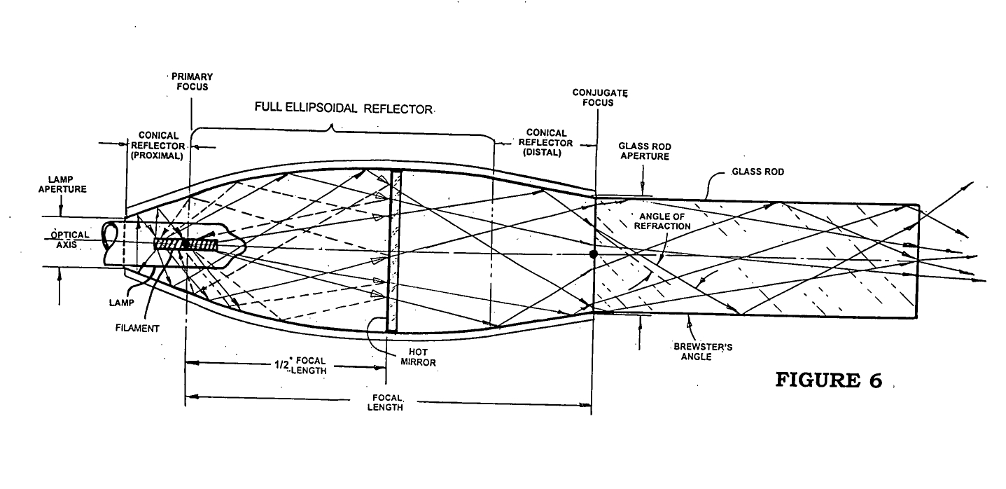

In FIG. 6, a side cross-sectional view of a full ellipsoidal reflector ellipsoidal reflector of FIG. 4, and according to the present invention, shows a the central full-ellipsoidal reflector area having a tangent proximal conical reflector extending to the lamp aperture; and tangent distal conical reflector extending to the glass rod aperture. The proximal conical reflector makes the proximal previously ineffective reflector portion of FIG. 5 into an optically effective portion. Similarly, the distal conical reflector makes the distal previously ineffective reflector portion of FIG. 5 into an optically effective portion. Thus the conical reflectors of FIG. 6 increase the efficiency of the full ellipsoidal reflector of FIG. 5.

Also included in FIG. 6 is a transverse heat-reflecting, visible-light-transmitting, transverse “hot Mirror”, positioned at ½ the focal length. The light rays emitted by the filament in FIG. 6 are shown as solid-line arrows that contain both visible light and heat. The hot mirror forms a “thermal mirror image” of the proximal half of the reflector that substantially removes the IR from the light and reflects the infrared rays back to the filament. The IR raises the filament temperature and increases the electrical resistance through the filament, thus reducing its power consumption. The visible light rays continue through the hot mirror and enter the glass rod at angles that are less than Brewster's angle of total internal reflection, minus the refraction angle of the rays incident on the proximal end of the glass rod.

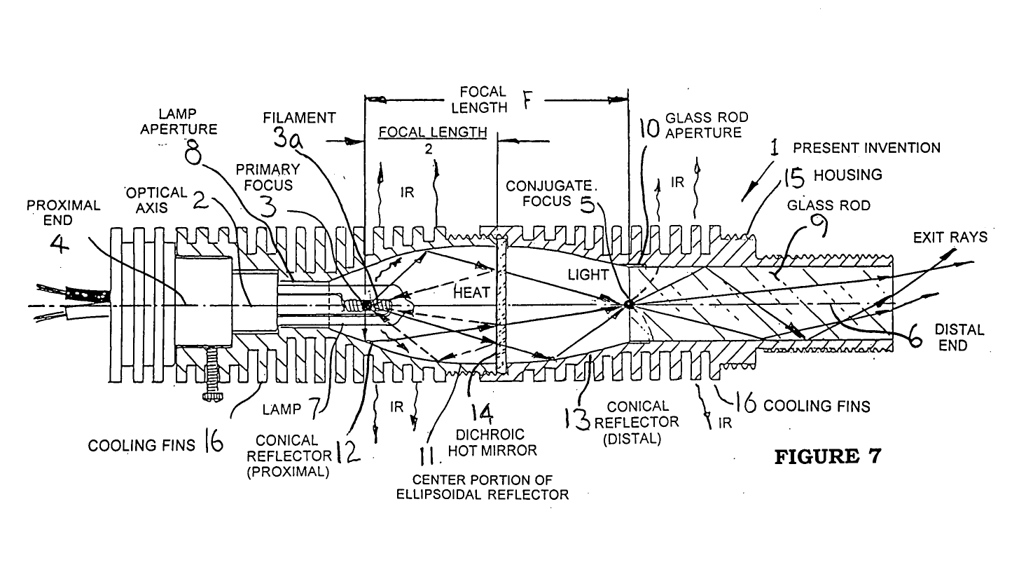

FIG. 7 is a side cross-sectional view of a side cross-sectional view of a projector luminaire 1 having an optical axis 2 with a primary focus 3 at a proximal end 4 and a conjugate focus 5 at a distal end 6. A lamp 7, which may be an incandescent (quartz-halogen) with a filament 3a or arc (metal halide) lamp, is disposed in a lamp aperture 8 at the proximal end of optical axis 2, and a glass rod 9 is disposed in a glass rod aperture 10 at the distal end of optical axis 2. Ellipsoidal reflector center portion 11 has a proximal-end conical portion 12 extending tangentially from the central reflector portion to lamp aperture 8, and a distal conical portion 13 extending tangentially from the central reflector portion 11 to the glass rod aperture 10. A heat-reflecting, visible-light-transmitting transverse “hot Mirror” 14 is positioned at ½ the focal length as also shown in FIGS. 6 and 7. The light rays emitted by the lamp filament are shown as solid-line arrows that contain both visible light and heat. The hot mirror forms a “thermal mirror image” of the proximal half of the reflector that substantially removes the IR from the light and reflects the infrared rays, shown as dash lines, back to the filament. The IR raises the filament temperature and increases its electrical resistance, thus reducing its power consumption. Visible light rays continue through the hot mirror and enter the glass rod at angles that are less than Brewster's angle of total internal reflection, minus the refraction angle of the rays incident on the proximal end of the glass rod. A second hot mirror is optional at the conjugate focal plane at the proximal end of glass rod 10.

The optical elements of projector luminaire 1 are enclosed in a housing 15 having inner surfaces of the central full-ellipsoidal reflector, as well as the proximal and distal conical reflectors have highly-reflective finishes, such as polished and/or vacuum-deposited aluminum. The exterior of housing 15 is provided with cooling fins 16 that have thermally emissive surfaces, such as black anodize.

### Operation

In operation, the high-efficiency projector of the invention allows no visible light to exit the luminaire except in the distal direction through an exit aperture. Within the projector a substantial portion of the infrared energy emitted from the light source is reflected back to the light source to increase its temperature

1. A light projector 1 including:
a generally ellipsoidal reflector on an optical axis 2, said reflector having proximal end primary focus 3 and a conjugate focus 5, spaced a focal length F in the distal direction;
a lamp 7 on the optical axis with its light source at the primary focus;
a glass rod 9 on the optical axis with proximal end in the plane of the conjugate focus; a heat-reflecting, visible-light transmitting hot mirror 14 on said optical axis, said hot mirror spaced a distance of F/2 in the distal direction from primary focus 3; and
a housing 15 supporting the reflector, the lamp, the glass rod and the mirror in alignment on the optical axis.

2. A light projector according to claim 1 in which the lamp is disposed within a proximal end aperture of the reflector and the glass rod is disposed within a distal end aperture.

3. A light projector according to claim 1 in which the generally ellipsoidal reflector has a proximal conical reflector portion extending tangentially to the lamp aperture, and a distal conical reflector extending tangentially to the glass rod aperture.

4. A light projector according to claim 1 in which the generally ellipsoidal reflector is integral with the housing.

5. A light projector according to claim 1 in which the generally ellipsoidal reflector has a reflective inner surface and a heat-emissive outer surface.

6. A light projector according to claim 1 in which the generally ellipsoidal reflector has a reflective inner surface and a heat-emissive outer surface comprising number of cooling fins.
